(19) United States
(12) Patent Application Publication
(10) Pub. No.: US 2006/0175423 A1
(43) Pub. Date: Aug. 10, 2006

(54) Illuminating apparatus for a water fountain

(76) Inventors: David Robert White, Sun City, CA (US); Neal Howard Ziff, Temecula, CA (US)

Correspondence Address: MICHAEL E. KLICPERA, PO BOX 573, LA JOLLA, CA, 92038-0573, US

(21) Appl. No.: 10/740,362

(22) Filed: Dec. 18, 2003

(51) Int. Cl. F21S 8/00

(52) U.S. Cl. 239/18

(57) ABSTRACT

The present invention relates to an illuminating water fountain apparatus that projects light from a series of high-intensity colored LEDs up into the water steams and spray. The main system comprises a body section with a light shield, a circuit board, a power source and a plurality of high intensity colored LEDs. The illuminating apparatus is designed to be used with a multi-tiered water head and a floating body. Other components include tubing and connections for attaching the system to a water source.

### FIELD OF THE INVENTION

The field of art to which this invention relates to is water fountains used with pool, spa, pond, and aquariums. More specifically, the present invention relates to a water fountain apparatus having illumination or lighting features that provides pleasurable characteristics with a safe and efficient design.

### BACKGROUND OF THE INVENTION

The practice of designing and manufacturing toys and accessories for pool and spas has developed to a point of some sophistication. Water toys provide entertainment value. Many water fountains for pools and spas have been generally designed for connection to existing water sources thereby making their implementation convenient. The pressurized inlet water is directed through usually a one, two or three tier head design that projects the water generally upward in various streams and spray configurations. The fountain generally is provided as a kit that contains the various components necessary to install the water fountain in different pool and spa designs. Also, the kits may make provisions for including various multi-head designs, e.g. two tiered or three tiered. The present invention illumination apparatus is generally attached with a multi-tiered water head and a floating body that is loosely anchored to the pool bottom such that the float assembly is generally centered within the water area. This water fountain is generally attached directly to the water inlet of the pool or spa. These water fountains provide a means for projecting water through a head design that results in a predictable shape with aesthetic and pleasing properties. In addition, water fountains are generally known to provide pleasing, white noise. Another property of these water fountains is that during the process of projecting water upward it functions to aerate the water.

It has been well known to mold or machine plastic or metallic components to form the parts for the pool toys and accessories. Various polymers are employed in fabricating the components of pool toys and accessories, but metallic components that are used and come in contact with the water must be resistance to certain chemical agents.

### SUMMARY OF THE INVENTION

It may be desirable in residential and public swimming pools and spas, as well as fish and plant ponds and aquariums, to provide an illuminating water fountain.

This invention relates to an illuminating water fountain apparatus that projects light from a series of high-intensity light emitting diodes (LEDs) up into the water streams and spray. While the present invention illumination apparatus is designed to be used in conjunction with presently manufactured multi-tiered water head and float systems, it can be sold as system or kit that consists of the multi-tiered water head, the present invention illumination apparatus, and the floating body. Other components necessary for operation include tubing and connections for attaching the illuminating water fountain to a water source.

Therefore, it is an object of the present invention to provide an illuminating water fountain for pools, spas, ponds and aquariums.

It is also an object of the present invention to provide an apparatus that enhances the visual presentation of water fountains during the night or in dark conditions.

### BRIEF DESCRIPTION OF THE DRAWINGS

The objects and features of the invention may be better understood with reference to the following detailed description of an illustrative embodiment of the invention, taken together with the accompanying drawings in which:

FIG. 1 is a perspective view of the present invention illuminating fountain apparatus shown in its typical location within a pool or fountain and connected to a water source.

FIG. 2 is a partial side view of the present invention designed to engage to a three-head water fountain and a floating device.

FIG. 3 demonstrates a side view of the present invention where the illuminating apparatus is engaged to a water fountain and showing the relative position of the light shield to the LEDs.

FIG. 4 is a sectional side view of the present invention engaged to a multi-head water fountain depicting where the electrical components are located and the chamber where water is directed through the fountain head.

### DESCRIPTION OF THE PREFERRED EMBODIMENTS

Residential pools and spas, as well as fish and plant ponds and aquariums, can have a removable water fountain connected to one of the pool or spas water systems for the purposes of projecting water through a head design that results in a predictable shape with aesthetic and pleasing properties. In addition, water fountains are generally known to provide pleasing, white noise. Another property of these water fountains is that the process of projecting water upward serves to aerate the water. To further enhance the appearance of the water streams and resulting spray, the present invention incorporates a plurality of high intensity LEDs positioned and focused substantially upwards to illuminate one or more of the water streams and sprays. The LEDs can be of one or more colors or intensities or designed to simulate any particular pattern in the water. The pattern can be predetermined, or programmed to respond randomly to audio stimulus in the environment.

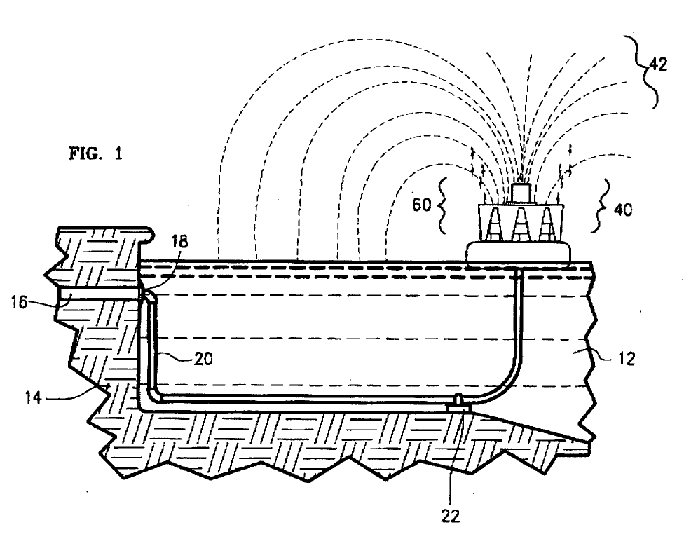

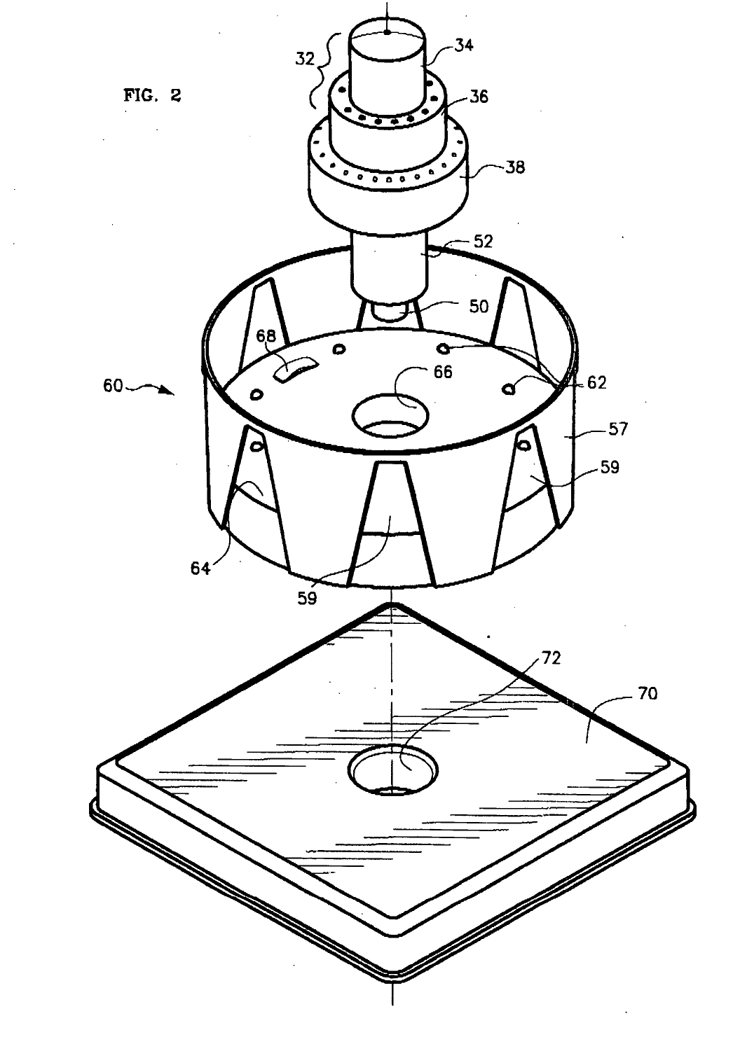

FIG. 1 illustrates the present illuminating fountain apparatus 60 shown in its typical location within a pool or spa 12 and connected to an inlet water source 16. Shown in this FIG. 1, is a typical in-ground pool or spa 12 where the walls of the pool or spa are supported by the surrounding ground 14. The Applicant also anticipates that the illuminating fountain apparatus 60 can also function with above ground pools, spas and ponds (not shown). As one of the components for obtaining water for the illuminating fountain, a connector 18 engaged to the inlet water source 16 that is securely engaged to a section of flexible polymeric tubing 20. At a particular point along the length of the tubing 20 an anchor 22 is attached such that the tubing's diameter is not crimped or compromised and functions to generally secure the fountain apparatus 60 in a central position within the pool or spa 12. As shown in more detail in FIG. 2, the present illuminating apparatus 60 is usually coupled to a float body 70 and a two or three tiered water head 32. The float body 70 generally has one internal chamber extending throughout its width and which functions to be in fluid communication with tubing 20. The multi-tiered water head 32 is in fluid communication with the inlet connector 18 and is fitted with a series of holes or lumen that function to propel water upwards in a particular spray pattern.

Also demonstrated in FIG. 1 is the water stream and spray 42 illuminated by the high intensity LEDS projection light upwardly 40 through the water streams and spray 42. The water spray patterns can be modified using various head designs. The high intensity LEDs are positioned circumferentially around the upper surface of a substantially circular body section 64. The number, intensity, and on-off frequency of LEDS can be altered to create different lighting pattern effects. Furthermore, different colored LEDs can be employed to provide different effects, for example, an alternating pattern of red and green LEDs positioned around the body section 64.

Now referring to FIG. 2 where a partial sectional view of the present invention is shown to usually cooperate with and is generally coupled to a multi-head water fountain 32, typically having an upper head 34 and a lower water head 38, and sometimes including a middle head 36. The present invention 60 can be sold individually or provided as a kit including a general fountain head 32 and floating device 70. The fountain head 32 and shank 52 are generally molded or machined from thermosetting polymers and need a relatively strong structure to withstand the pressures that the head 32 and its water ports are exposed to. Supporting and providing flotation characteristic for both the present invention 60 and example three-tiered fountain head 32 is a float body 70 generally fabricated from a thermoplastic polymers, such a high density polyethylene. The float body 70 is substantially hollow and contains an internal lumen or pocket that contains primarily air. The float body shown here is square in shape but also could be rectangular, circular, or oval. The float body could also simulate an organic setting such as a rock mountain. Extending throughout the width of the float body 70 is a lumen 72 which has an inside diameter that closely approximates the outside diameter of the shank 52 extending from the bottom of the fountain head 32.

Sandwiched between the fountain head 32 and the float 70 is the present invention illuminating apparatus 60. The illuminating apparatus 60 comprises a substantially circular body 64 section with a plurality of high intensity LEDs 62 protruding through the upward facing surface 63 of the body section 64. A shield 57 with slots 59 surrounds the circumference end of the circular shaped body 64. The shield 57 functions to direct and focus light generated from the LEDs 62 in the upward direction towards the water spray 42. The slots 59 function to allow water accumulating from the spray 42 that falls within the light shield 57 to exit back into the water source 12. Both the body 64 and shield 57 can be molded from either thermoplastic or thermosetting polymers. The body section 64 is usually molded (but can be machined) to create the hole pattern which allows the LEDs 62 to protrude through the upper facing surface 63. Generally the body section 64 and the shield 57 (with slots 59) are molded together as a single polymeric piece. However, the body section 64 and shield 57 can be molded or machined individually, and then secured together using adhesive techniques, plastic welding and other physical attachment means. Also shown is an on-off switch 68 that is in electronic communication with the power source 82 and the LEDs 62.

The LEDs 62 of the present invention utilize standard technology which currently offers high intensity and optical output in the range of 10-50,000 milli-candelas (MCDs) with view angles generally greater than 70 degrees. This LED technology also has the capacity of low power consumption that can provide sufficient energy for hours using battery power. As only one example of an opt-electronic manufacturer, Kingbright Corporation located in the City of Industry in California manufactures LEDs 62 which emit either white light, green, red or blue color. Other manufacturers provide similar high optical output LEDs that emit green, red or mutli-colors. This LED technology provides sufficient light energy to generally illuminate water spray 42 for the present invention. The LEDs 62 are mounted to a circuit board 84 (more clearly shown in FIG. 4) and protrudes through the holes of the body section 64.

Extending throughout the width of the float, is a lumen 66 with an inside diameter that approximates the outside diameter of the shank 52 such that the shank can extend through the lumen 66. In this configuration, the body section 64 becomes generally engaged to the shank 52. It is not as important that the outside diameter of the shank 52 provide a tight of fit between it and lumen 66.

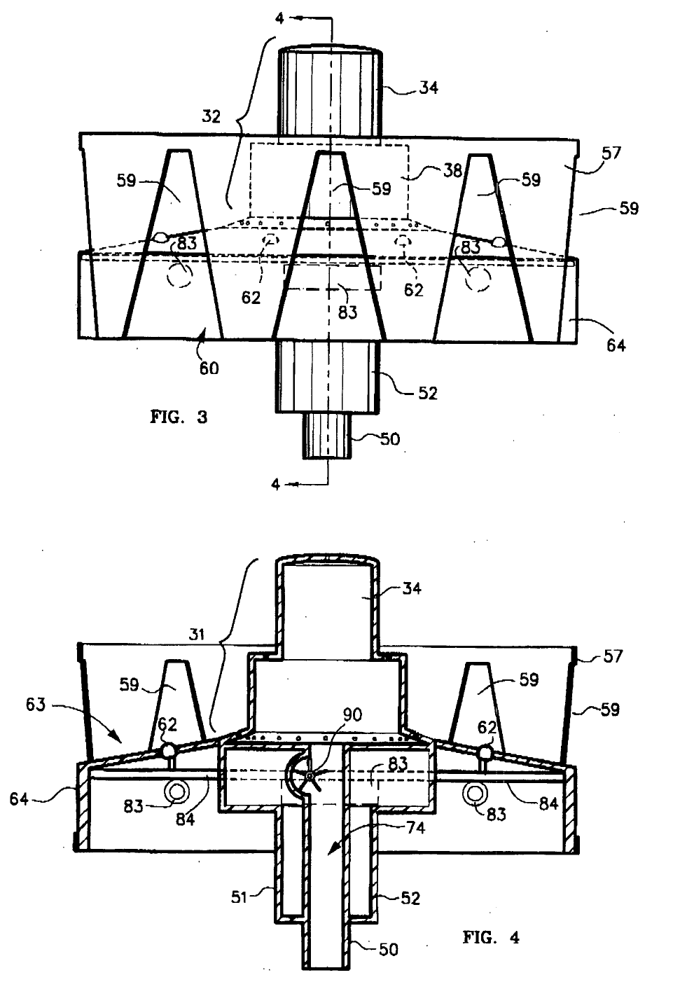

FIG. 3 demonstrates a side view of the present invention where the illuminating apparatus 60 is engaged to a multi-tiered water head 32 and shows the relative position of the light shield 57 to the LEDs 62. The multi-tiered water head 32 usually including an upper head 34 and lower head 38 is coupled to the present invention illumination apparatus 60. Also shown is shank 52 which approximately engages the inside lumen of the float body and tubing connector 50 extending from the shank 52. The illumination body section 64 has an upward facing surface 63 which has a plurality of high intensity LEDs 62 protruding through and facing upwards. Surrounding the circumference of the body section 64 is light shield 57 with slots 59. The LEDs 62 are generally positioned such that they are substantially centered between the physical section of the shield 57, away from the slots 59, and functioning to direct the generated light upward.

FIG. 4 shows a sectional side view of the present invention engaged to a multi-head water fountain 31 with the illumination apparatus 60 engaged near the bottom. The sectional side view of a multi-tiered water head 32 shows that the head 32 is connected to the shank 52 by means of a water chamber 74. A tubing connector 50 extends from the shank 52. Also shown in sectional view is the body 64, shield 57 with slots 59, and circuit board 84. Mounted within the body section 64 and in a position that the LEDs 62 (and switch 68) protrudes through the body 64 is a substantially circular circuit board 84. The circuit board 84 is fabricated from typical materials and is constructed using known techniques. The substantially circular circuit board 84 is specifically designed to mount the LEDs 62 and switch 68 utilizing standard soldering techniques to provide electrical connections. It is also anticipated by the Applicant that the circuit board can also be populated with a microprocessor, voltage regulator, memory banks and other discrete members (not shown) for additional electrical control of the LEDs 62 (e.g. flashing, alternating light patterns). On the bottom of the circuit board 84 provisions are made for mounting a plurality of batteries 83 that perform as the power source for the circuit. The mount is engaged to the circuit board 84 and has the capability for easy removal of batteries for exchanging exhausted cells. The batteries 83 are in electrical communication with the switch 68 and the LEDs 62. As an example, one or more typical AA type alkaline or rechargeable batteries (e.g. nickel cadmium) can be used as the power source

As shown, the illumination body section 64 with the upward facing surface 63 includes a plurality of high intensity LEDs 62. The LEDs 62 are mounted to the circuit board 84 and protrude through the wall thickness of the body 64 with a portion of the head extending beyond the surface.

Water under pressure enters from the tubing connected to the water connector 53, up through the water chamber 74 and into the head 31. Water pressure from the water source forces the water through the water chamber 74 and out holes in the water head 31 to form a water spray or shower pattern. The wall thickness of the tubing connector 50 and the shank 52 must be fabricated from a material with an appropriate dimension or thickness 51 to resist the stresses applied when water under pressure is forced through the water head 31. The illumination apparatus 60 projects light from its LEDs 62 through the water spray or shower pattern.

Also shown in this Figure is another embodiment of the present invention that incorporates an optional sensing/generating member 90 positioned within the water chamber 74. The sensing/generating member 90 can function to detect water flow and thus serve as the switching mechanism. In addition, the sensing/generating member 90 can include a rotating wheel assembly that functions to generate electrical power when flowing water is present. The electrical power generated from the sensing/generating member 90 can function to power the LEDs 62 independently or re-charge the batteries 83. Additionally, if the sensing/generating member 90 is designed to produce electrical power, the circuit board can be populated with components that function as a regulator for recharging the battery source 83. Also contemplated by the Applicant but not shown is a series of solar cells mounted on the body section 64 of the illumination apparatus that have the function to recharge the battery source 83. The battery source 83 can be a standard non-rechargeable type batteries, e.g. alkaline, which must be replaced upon exhaustion of its charge, or can be of the typical rechargeable type. Electrical communication will be necessary to connect the sensing/generating member 90 to the circuit board.

While the invention has been described in detail and with reference to specific embodiment thereof, it will be apparent to one skilled in the art that vari us changes and modifications can be made therein without departing from the spirit and scope thereof.

What is claimed:

1. An illuminating water fountain kit comprising:
a float base having a chamber extending throughout its width;
a multi-tiered water head, said water head having a shank extending from the bottom of said head; and
a light emitting diode illuminating apparatus.

2. An illuminating water fountain kit as recited in claim 1, wherein said illuminating apparatus contains a plurality of high intensity light emitting diodes.

3. An illuminating water fountain kit as recited in claim 1, wherein said illuminating apparatus includes a circuit board, a switch, and a power source, said circuit board electronically connecting together said power source, switch, circuit board, and one or more light emitting diodes.

4. An illuminating water fountain kit as recited in claim 3, wherein said power source is one or more batteries.

5. An illuminating water fountain kit as recited in claim 3, where said power source is a generator propelled by a flow of water running through said fountain.

6. An illuminating water fountain kit as recited in claim 3, wherein said power source is one or more solar cells.

7. An illuminating water fountain kit as recited in claim 3, wherein said power source is one or more batteries that maintain their charge by electrical power generated from a generator, solar cells, or any combination thereof.

8. An illuminating water fountain kit as recited in claim 2, further comprising that said plurality of light emitting diodes comprise more than one color.

9. An illuminating water fountain kit as recited in claim 1, further comprising a section of tubing having a distal end and a proximal end, with a lumen in water communication throughout, said distal end attached to a water source and said proximal end attached to the shank.

10. An illuminating apparatus for a water fountain comprising:
a body section, said body section having a light shield, said body section designed to couple with a water fountain;
a circuit board, said circuit board engaged to said body;
a switch on said body and in electrical communication with said circuit board;
one or more light emitting diodes; said light emitting diodes protruding through said body and in electrical communication with said circuit board; and
a power source; said power source mounted to and in electrical communication with said circuit board.

11. An illuminating apparatus as recited in claim 10, further comprising a plurality of slots in said light shield.

12. An illuminating apparatus as recited in claim 10, wherein said power source is one or more batteries.

13. An illuminating apparatus as recited in claim 10, where said power source is a generator propelled by a flow of water running through said fountain.

14. An illuminating apparatus as recited in claim 10, wherein said power source is one or more solar cells.

15. An illuminating apparatus as recited in claim 10, wherein said power source is one or more batteries that maintain their charge by electrical power generated from a generator, solar cells, or any combination thereof.

16. An illuminating apparatus as recited in claim 10, further comprising that said plurality of light emitting diodes comprise more than one color.

17. An illuminating apparatus as recited in claim 10, further comprising controlling circuitry in electrical communication with the circuit board, the power source and the light emitting diodes, said controlling circuitry have the function to vary on-off cycles of each light emitting diode.
